(19) United States
(12) Patent Application Publication
(10) Pub. No.: US 2016/0053978 A1
(43) Pub. Date: Feb. 25, 2016

(54) Flashing Treetop Star

(71) Applicant: Hua-Cheng Pan, Tainan City (TW)

(72) Inventor: Chih-Liang Wang, Tainan (TW)

(21) Appl. No.: 14/463,637

(22) Filed: Aug. 19, 2014

(51) Int. Cl. F21V 23/00; H05B 33/08; H05B 37/02; F21V 8/00

(52) U.S. Cl. CPC F21V 23/009; G02B 6/0081; H05B 33/0845; H05B 33/0806; H05B 33/0857; H05B 37/0272; F21W 2121/04

(57) ABSTRACT

A flashing treetop star includes: a mounting base, a light guide unit, a support member, and a circuit module. The light guide unit includes two shaped light-transmitting plates that are mounted to the mounting base. The support member is in the form of a cone and coupled to an underside of the mounting base. The circuit module includes two light-emitting elements respectively corresponding to the light-transmitting plates and a control circuit that controls each of the light-emitting elements to get lightening and darkening in a given sequence. As such, when a power supply is conducted on, each of the light-emitting elements gives off light transmitting to the interiors of the light-transmitting plates to make each of the light-transmitting plates to show an effect of light flashing in response to the lightening and darkening of the corresponding one of the light-emitting elements.

### TECHNICAL FIELD OF THE INVENTION

The present invention generally relates to a Christmas lighting decoration, and more particularly to a structure of a treetop star that provides a flashing effect.

### DESCRIPTION OF THE PRIOR ART

In the Western society, Christmas is a holiday when family members gather together to celebrate. Often, Christmas trees are used for decoration in order to improve the happy atmosphere of the holiday. This holiday recently attracted the attention in the Eastern society and thus, the Christmas trees become an indispensable decoration in the holiday.

The Christmas trees are usually evergreen conifer, such as spruce and pin, symbolizing every lasting of lives. There are also artificial Christmas trees and white Christmas trees. For whatever type of the Christmas tree, colorful lights, decorations, gifts, angel figures, and the likes are commonly used to decorate the Christmas trees. Each of the Christmas trees needs a large star (commonly referred to as a treetop star) attached to the treetop, symbolizing the Star that guides the Magi to Jesus. Traditionally, only the master of the house is allowed to hang the Star of Hope to the treetop and no one else may do so in substitute.

However, the conventional treetop stars have structures that are similar without significant variation or change. Thus, it is an important issue to provide a treetop star that includes an innovated design to improve the value and the style thereof and thus improving the performance of utilization and market competition power.

### SUMMARY OF THE INVENTION

An object of the present invention is to provide a treetop star with a flashing effect, which comprises a design with an innovated structure to improve market competition power of a product thereof.

Thus, the present invention provides a flashing treetop star, which comprises:

a mounting base, which comprises at least two spaced mounting holes formed therein;

a light guide unit, which comprises at least two light-transmitting plates, each of the light-transmitting plates being a board having a predetermined thickness and shape to allow light to transmit therethrough and having an end from which a fixing section extends, the fixing sections being respectively received in the corresponding ones of the mounting holes, the fixing sections each comprising a light incident surface at the side opposite to the light-transmitting plate;

a support member, which is made in the form of a cone that is configured for being attached to a top of a Christmas tree and has an end coupled to an underside of the mounting base;

a circuit module, which comprises at least one light-emitting element corresponding to each of the light incident surfaces and a control circuit that controls each of the light-emitting elements to lighten and darken in a sequence, the circuit module being adapted to connect to a power supply to receive electricity therefrom for driving each of the light-emitting elements.

As such, when the power supply is conducted on, each of the light-emitting elements gets lightening and darkening in a given sequence and lights pass through the light incidence surfaces into the interiors of the light-transmitting plates so that the light-transmitting plates show a flashing effect in response to the lightening and darkening of the light-emitting elements.

With the above-described technical solution, the problems of the conventional power generation devices that the conditions for installation thereof are severe, they are readily susceptible to influence by weather, they are easily damaged and get quick deterioration, they cannot maintain long term power generation operations, and the economic benefit is low can be overcome and the above-mentioned advantages can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the present invention in an assembled form.

FIG. 2 is an exploded view of the present invention.

FIGS. 3 and 4 are cross-sectional views showing the present invention in flashing conditions

FIGS. 5 and 6 are schematic views showing the present invention in flashing conditions.

FIGS. 7, 8, and 9 are schematic views illustrating examples of assembling of the present invention.

FIG. 10 is an exploded view illustrating a condition of use of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

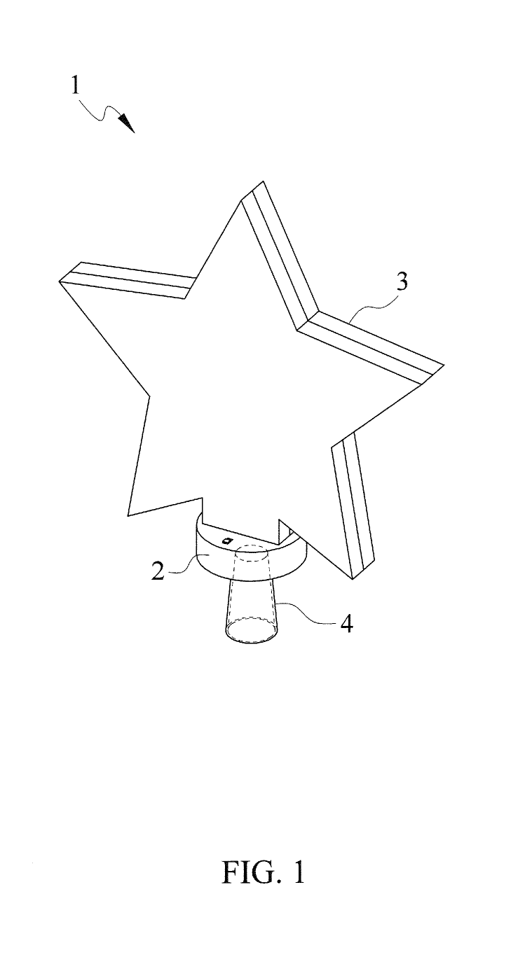

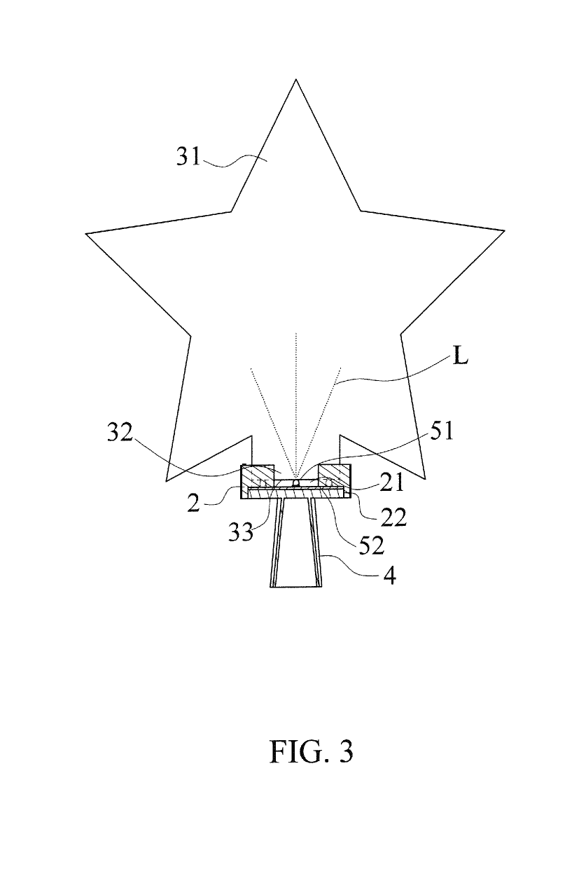

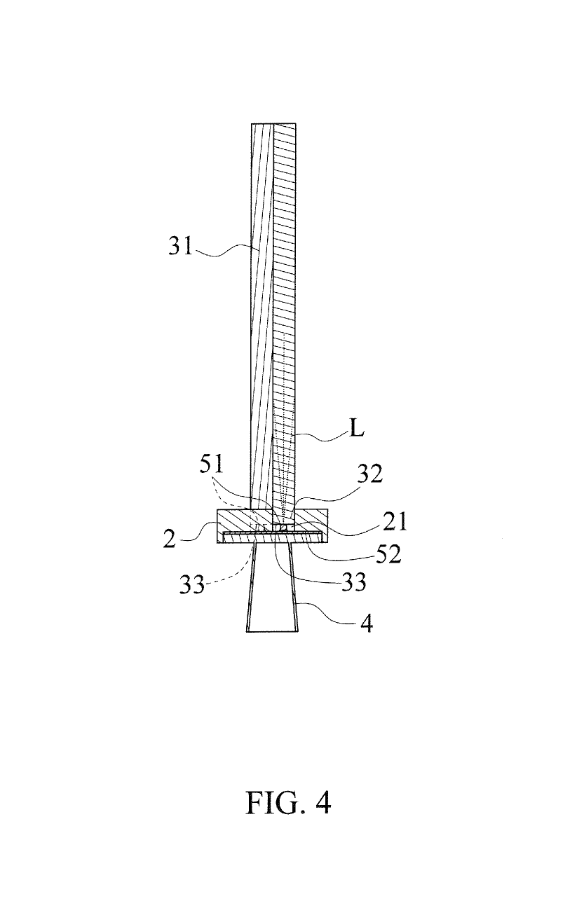

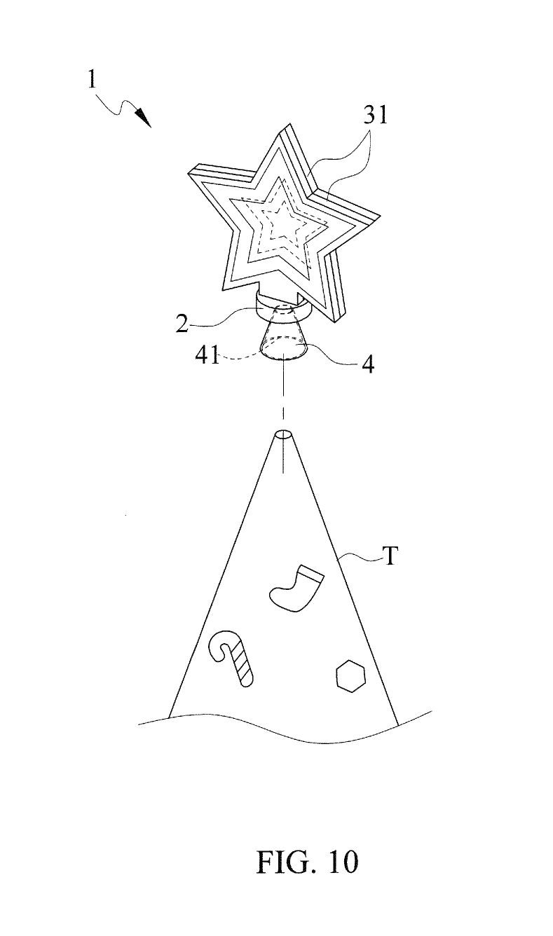

Referring to FIGS. 1-4 and 10, a flashing treetop star (1) according to the present invention is provided as a lighting device for use with a Christmas tree by being attached to a top of the Christmas tree. The treetop star (1) generally comprises: a mounting base (2), a light guide unit (3), a support member (4), and a circuit module (5), which will be described as follows:

The mounting base (2) comprises a plurality of mounting holes (21) that is arranged to alternate and spacing with respect to each other. The mounting base (2) has a bottom in which a cavity (22) is formed. In the instant embodiment, the mounting base (2) is not limited to any specific shape may be for example a geometric shape, such as circle and polygon. The mounting base (2) is also not limited to being made of any specific material and may be made of for example metals or plastics and is preferably of a structure that does not allow transmission of light therethrough.

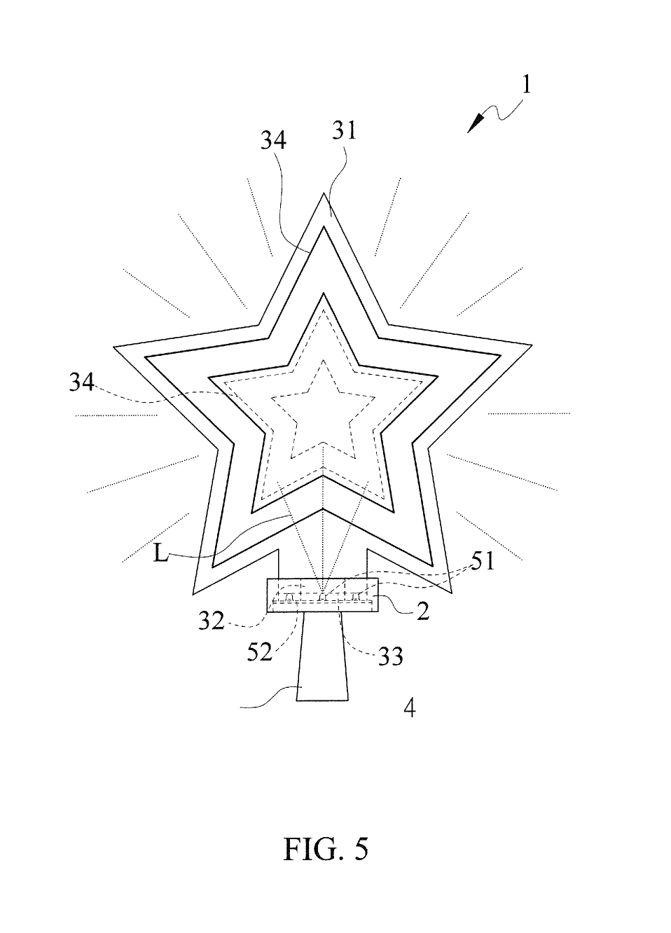

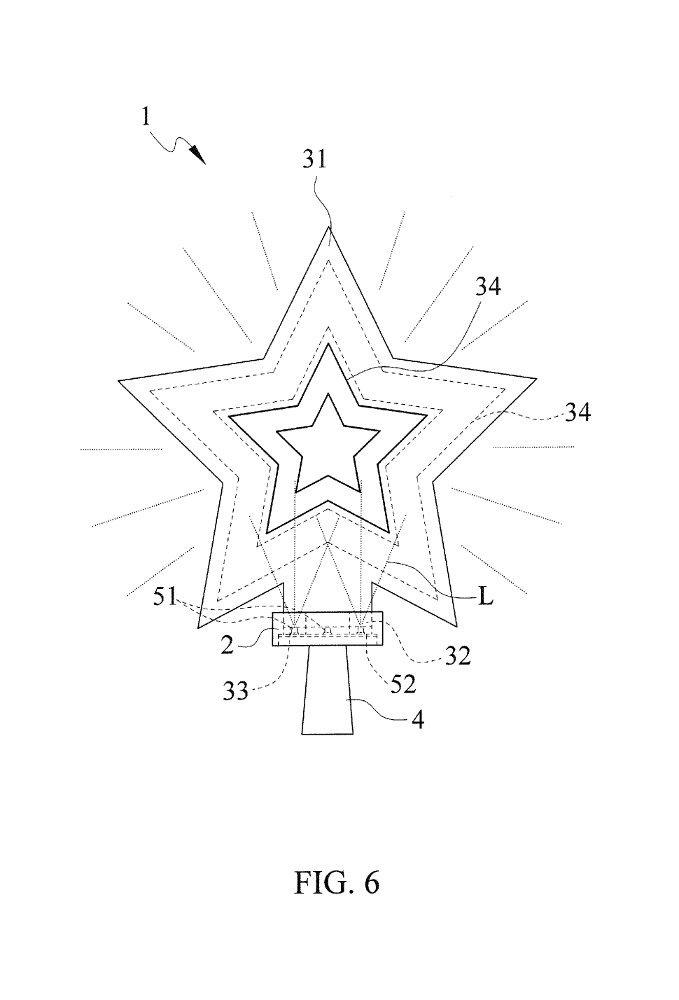

The light guide unit (3) comprises two light-transmitting plates (31). Each of the light-transmitting plates (31) comprises a flat board that has a shape and thickness allowing light to transmit therethrough and has an end from which a fixing section (32) extends. The fixing section (32) is inserted into a corresponding one of the mounting holes (21). The fixing section (32) comprises a light incident surface (33) at the side opposite to the light-transmitting plate (31). In the instant embodiment, the light-transmitting plate (31) is of a shape of a pentagram. The fixing sections (32) of the light-transmitting plates are respectively in the form of a recess and a protrusion, but are not limited to such configurations. The light-transmitting plates (31) can be of other shapes that may serve as a treetop star, such as a star hexagon, a heart, an animal, and a plant and is made of a light-transmitting material, such as glass and plastics. Colorants may be added in the material during the manufacturing process to achieve color variation of the light-transmitting plates (31). Further, each of the light-transmitting plates (31) has a surface on which patterns (34) are formed and may include various types of patterns, such as figures and symbols for prompting the atmosphere of Christmas holiday and trademarks, and can be formed through printing or engraving. In the instant embodiment, a star pattern is used as an example for illustration, as shown in FIGS. 5 and 6.

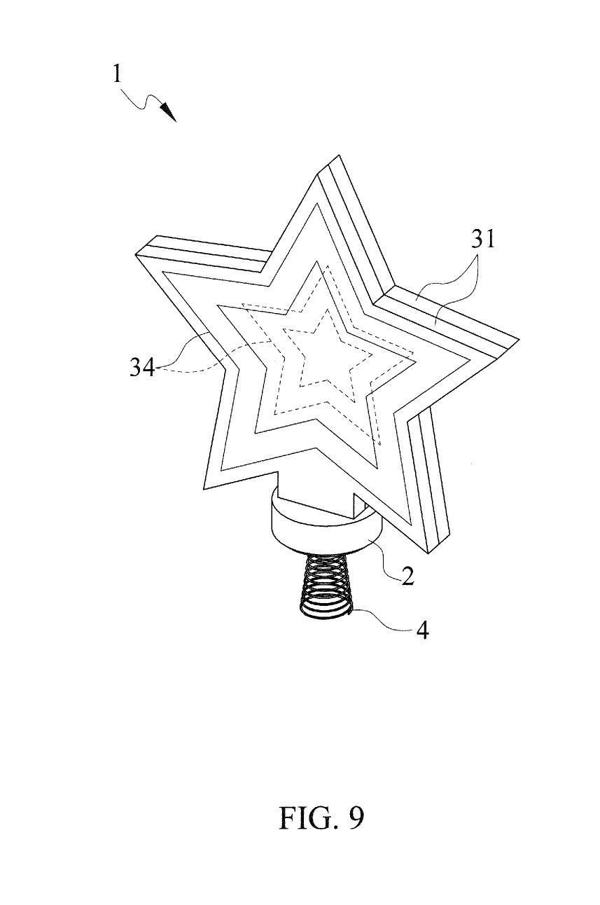

The support member (4) is made in the form of a cone to be attached to a top of a Christmas tree (T) and has an end coupled to an underside of the mounting base (2) and received in the cavity (22). In the instant embodiment, the support member (4) comprises a hollow shell that comprises an opening (41) that is opposite to the mounting base (2) and is in communication with the hollow interior thereof. The opening (41) can be fit over the top of the Christmas tree (T) for mounting. Further, the support member (4) can alternatively be a cone formed by coiling a spring, as shown in FIG. 9.

The circuit module (5) comprises at least one light-emitting element (51) corresponding to each of the light incident surfaces (33) and comprises a control circuit (52) that control the light-emitting elements (51) to lighten and darken by following a predetermined sequence and timing. The control circuit (52) is electrically connectable to a power supply to receive electricity therefrom for energizing the light-emitting elements (51). It is noted here that the control circuit (52) has an outer circumference that is securely fixed in the cavity (22) of the mounting base (2) with the light-emitting elements (51) respectively received in the mounting holes (21) to achieve contact engagement with the light incident surfaces (33). In the instant embodiment, the light-emitting elements (51) are light-emitting diodes (LEDs) and the number can be increased or decreased in accordance with the light-transmitting plates (31). The light-emitting elements (51) are controlled by the control circuit (52) to achieve change of light colors in order to enhance the variability thereof.

Referring to FIGS. 5 and 6, in a condition that the power supply is conducted on, the light-emitting elements (51) are controlled by the control circuit (52) to lighten and darken according to the predetermined sequence and timing and lights (L) enter through the light incident surfaces (33) into and travel within the light-transmitting plates (31) to allow the light-transmitting plates (31) to show a flashing effect with the lightening and darkening of the light-transmitting elements (51) associated therewith. The patterns (34) formed on the surfaces of the light-transmitting plates (31) are irradiated by the lights (L) to make the present invention more prominent and eye-catching. In the instant embodiment, the patterns (34) of the light-transmitting plates (31) are arranged in an alternate and shrinking way so that when the light-emitting elements (31) are energized, the patterns (34) show a layered visual effect.

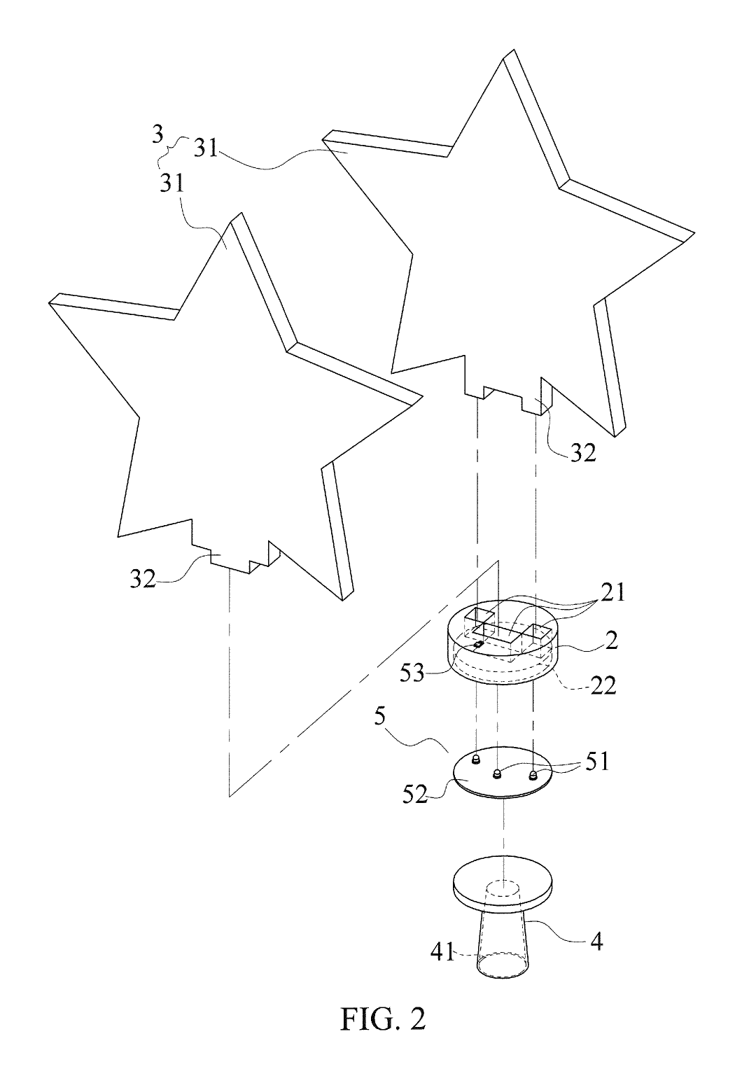

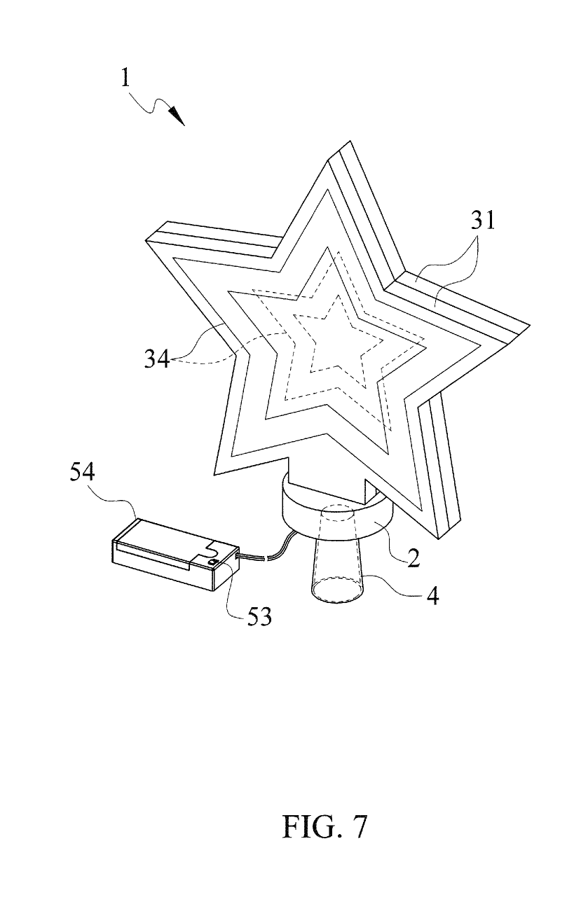

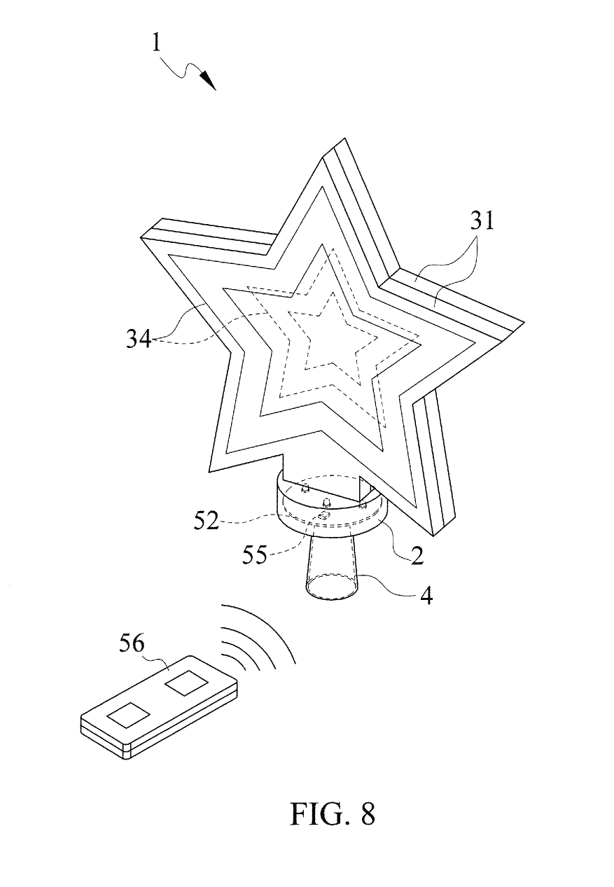

Referring to FIGS. 7 and 8, which shows example of the assembling of the present invention, the circuit module (5) further comprises a power switch (53) for activating and de-activating the power supply. The power switch (53) is electrically connected to the control circuit (52) and is suitable for various sizes of the Christmas tree (T). The power switch (53) can be mounted to an end of the mounting base (2) as shown in FIGS. 1 and 2 and this arrangement is fit to a Christmas tree of a small size. A user is allowed to directly operate it for activation and de-activation without the need of being assisted with other devices. Alternatively, as shown in FIG. 7, a battery box (54) is additionally provided and is electrically connected to the control circuit (52) to serve as power supply. The power switch (53) is mounted to one side of the battery box (54). The battery box (52) can be deposited and received under a large-sized Christmas tree for easy access for operation by a user. The battery box (54) is well known and further description will be omitted.

Alternatively, as shown in FIG. 8, the circuit module (5) further comprises a signal receiver (55) and a remote control (56). The signal receiver (55) is electrically connected to the control circuit (52). The remote control (56) is operable to transmit, in a wireless manner, a control signal to the signal receiver (55) to drive the light-emitting elements (51) to give off light. As such, the operation of the present invention is easy.

In summary, the present invention possesses the following advantages:

(1) The present invention provides light-emitting elements that can be operated to show a flashing effect of lightening and darkening in a predetermined sequence and also to change color of light to expand the variability thereof

(2) The present invention provides light-transmitting plates, which can be added with colorants during the manufacture thereof and are irradiated by lights from light-emitting elements to greatly upgrade the visual effect of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A flashing treetop star, comprising:
a mounting base, which comprises at least two spaced mounting holes formed therein;
a light guide unit, which comprises at least two light-transmitting plates, each of the light-transmitting plates being a board having a predetermined thickness and shape to allow light to transmit therethrough and having an end from which a fixing section extends, the fixing sections being respectively received in the corresponding ones of the mounting holes, the fixing sections each comprising a light incident surface at the side opposite to the light-transmitting plate;
a support member, which is made in the form of a cone that is configured for being attached to a top of a Christmas tree and has an end coupled to an underside of the mounting base; and
a circuit module, which comprises at least one light-emitting element corresponding to each of the light incident surfaces and a control circuit that controls each of the light-emitting elements to lighten and darken in a sequence, the circuit module being adapted to connect to a power supply to receive electricity therefrom for driving each of the light-emitting elements;
wherein the mounting base comprises a cavity formed therein and the control circuit is received in the cavity and has an outer circumference that is securely fixed in the cavity.

2. The flashing treetop star according to claim 1, wherein each of the light-transmitting plates has a surface on which patterns are formed.

3. The flashing treetop star according to claim 1, wherein he circuit module further comprises a power switch, which selectively conducts on or cut off the electricity supplied from the electrical supply, the power switch being electrically connected to the control circuit.

4. The flashing treetop star according to claim 1, wherein the circuit module further comprises a signal receiver and a remote control, the signal receiver being electrically connected to the control circuit, the remote control being operable to transmit, in a wireless manner, a control signal to the signal receiver to drive the light-emitting elements.

5. The flashing treetop star according to claim 1, wherein the support member is formed by coiling a spring.

6. he flashing treetop star according to claim 1, wherein each of the light-emitting elements is controllable by the control circuit to change color of light.

7. The flashing treetop star according to claim 1, wherein each of the light-transmitting plates comprises a light-transmitting plate having a predetermined color.
